(19) United States
(12) Patent Application Publication
(10) Pub. No.: US 2007/0143814 A1
(43) Pub. Date: Jun. 21, 2007

(54) Method of user interface for time shift function and PVR using the same

(75) Inventor: Sang-Jun Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/595,937

(22) Filed: Nov. 13, 2006

(30) Foreign Application Priority Data
Dec. 21, 2005 (KR) 10-2005-0126942

(51) Int. Cl. H04N 7/173; H04N 7/16; G06F 13/00; H04N 5/445; G06F 3/00

(52) U.S. Cl. 725/134; 725/142; 725/89; 725/37

(57) ABSTRACT

A method of displaying a user interface for a time shift function and a personal video recorder (PVR) using the same are provided. The method includes: displaying a user interface on a screen; displaying, on the user interface, a broadcasting time of a currently playing program; and displaying a status of broadcast recording on the user interface. The user interface is in the form of an analog watch.

### CROSS-REFERENCE TO RELATED PATENT APPLICATIONS

This application claims priority from Korean Patent Application No. 10-2005-0126942, filed on Dec. 21, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to a time shift function for a personal video recorder (PVR), and more particularly, to a method of user interface for a time shift function and a PVR using the method.

2. Description of the Related Art

Personal video recorders (PVRs) are new digital recorders which record and play broadcast programs on hard disks or memory chips, unlike video cassette recorders (VCRs) which store video signals in magnetic tapes. Basic functions of the PVRs are not much different from existing VCRs in the sense that the PVRs also store and play broadcast programs. Differences between the PVRs and the VCRs lie in the fact that the PVRs record broadcast programs on the hard disks and play the broadcast programs in the same manner that computers play files. In addition, unlike VCRs, PVRs include a central processing unit (CPU) for playing broadcast programs, a memory chip, which stores an operating system and software, so as to play broadcast programs, and a large-capacity hard disk for storing broadcast content.

In a PVR, when a user selects a channel, a signal of a current broadcast program is automatically digitally stored in a hard disk while the broadcast program being played on a screen. When the user presses a “stop” button and then presses a “play” button, the broadcast program is played starting from the point where a playing of the stored signal was last stopped. Further, the user can select a specific part of the broadcast program to play. For example, the broadcast program can be replayed or played in a slow motion, and portions of a program can be skipped according to a user's choice. This function is called a “time shift”.

FIG. 1 shows a common user interface for a time shift, displayed in the form of a bar. Referring to FIG. 1, a user interface 110 for a time shift is displayed in the form of a bar, and is positioned at a lower portion of a screen 100 on which video data is displayed. The user interface 110 indicates a current time 40, a broadcasting time 20 of a current display program, a record starting time 10, and a current playing status 30. In FIG. 1 for example, the current time is 11:30, the broadcast program started recording at 11:00, and a user is watching a program which was broadcasted at 11:20. However, the user interface 100 of FIG. 1 displayed in the form of a bar is not user-friendly for those who are not familiar with a time shift function.

### SUMMARY OF THE INVENTION

The present invention provides a method of a user-friendly user interface for a time shift function, and a PVR using the method.

According to an aspect of the present invention, there is provided a method of displaying a user interface for a time shift function, the method comprising: displaying a user interface on a screen; displaying, on the user interface, a broadcasting time of a currently playing program; and displaying a status of broadcast recording on the user interface. The user interface is in the form of an analog watch.

In the aforementioned aspect of the method, the displaying the broadcasting time of the currently playing program may comprise displaying an hour and a minute hand which indicate the broadcasting time of the program.

In addition, the displaying the status of broadcast recording may comprise displaying a figure on the user interface, where a size of the figure changes in proportion to the duration of the program.

In addition, the displaying the status of broadcast recording may comprise changing a position of the figure according to the broadcasting time.

In addition, the method may further comprise displaying, on the user interface, information on whether a currently displayed portion of the program is a recorded portion or a portion which is currently being broadcast.

In addition, the displaying information on whether the currently displayed portion of the program is a recorded portion or a portion which is currently being broadcast may comprise displaying the information using different colors.

In addition, the displaying the status of broadcast recording may comprise displaying the duration of the program using a circular arc.

In addition, a first end of the circular arc may indicate a recording starting time, and a second end of the circular arc may indicate a current time.

In addition, the second end of the circular arc may meet an extended line of the minute hand, and the first end of the circular arc may be spaced apart from the second end of the circular arc in a counter clockwise direction by a certain degree, where each six degrees of a central angle indicates a recording time of one minute.

In addition, the displaying the duration of the program may comprise indicating the duration of recording in the form of a fan shape that is formed by the area between the center of the user interface and the circular arc.

In addition, the method may comprise: receiving a time shift instruction; and changing the locations of the hour hand and the minute hand to indicate a time in response to the time shift instruction.

According to another aspect of the present invention, there is provided a PVR having a time shift function, the PVR comprising: a broadcast receiving unit which receives broadcasting data; a storing unit which stores the received broadcasting data; a display unit displays a user interface for a time shift and which plays the broadcasting data; and a control unit which controls playing and recording of the received broadcast data, displays the user interface for the time shift in the form of an analog watch on the display unit, and controls the display unit to display a broadcasting time of a currently playing program and a status of broadcasting recording.

In addition, the PVR may further comprise an input unit which receives a user instruction, wherein, when the control unit receives a time shift instruction via the input unit, the control unit controls the display unit to change the locations of the hour hand and the minute hand in response to the time shift instruction.

In addition, the input unit may comprise a jog wheel, an a time shift instruction is transmitted to the control unit according to a rotation direction of the jog wheel.

### BRIEF DESCRIPTION OF THE DRAWINGS

The above and other exemplary aspects and advantages of the present invention will become more apparent from the following detailed description of exemplary embodiments thereof with reference to the attached drawings in which:

FIG. 1 shows a common user interface for a time shift, displayed in the form of a bar;

FIG. 2 shows a user interface for a time shift, which is displayed on a screen in the form of an analog watch, according to an exemplary embodiment of the present invention;

FIG. 3 shows a user interface for a time shift, which is displayed in the form of an analog watch according to an exemplary embodiment of the present invention;

FIG. 4 is a flowchart of a method of a user interface for a time shift function according to an exemplary embodiment of the present invention;

FIGS. 5A to 5C show the operations of a user interface for a time shift according to an exemplary embodiment of the present invention;

FIG. 6 shows an example of a user input device according to an exemplary embodiment of the present invention; and

FIG. 7 is a block diagram of a PVR using a user interface for a time shift according to an exemplary embodiment of the present invention.

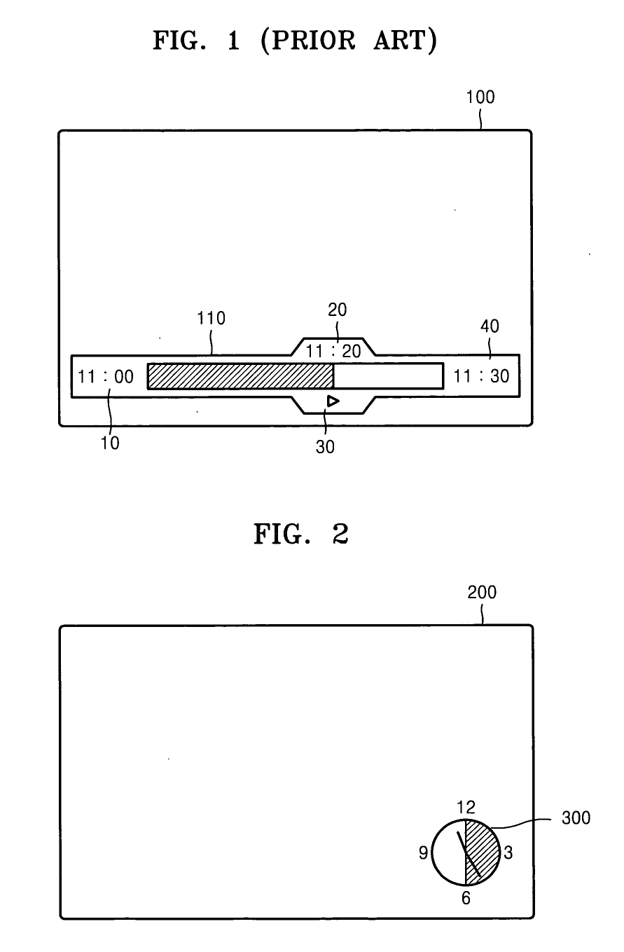

### DETAILED DESCRIPTION OF EXEMPLARY EMBODIMENTS OF THE INVENTION

Hereinafter, the present invention will be described in detail with reference to exemplary embodiments of the invention and the attached drawings.

FIG. 2 shows a user interface for a time shift, which is displayed on a screen in the form of an analog watch familiar to ordinary users, according to an embodiment of the present invention. When the time shift function is activated, a user interface 300 appears at the lower right portion of a screen 200. However, the location of the user interface 300 is not limited thereto. Referring to FIG. 2, a current time is 11:30, a broadcast program is recorded from 11:00 for 30 minutes, and a user is watching a portion of a recorded program that was originally broadcast at 11:20.

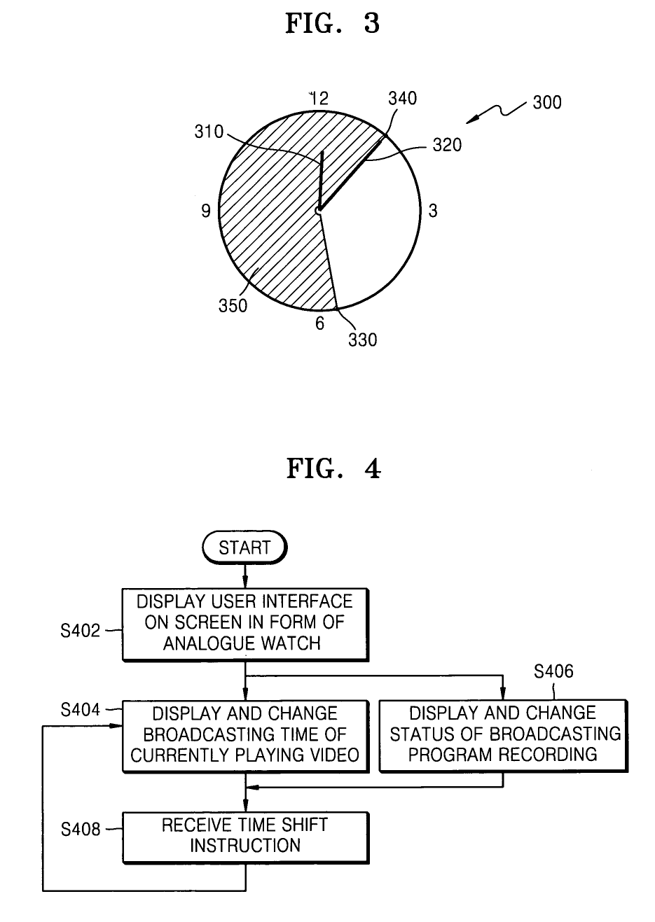

FIG. 3 shows the user interface in the form of an analog watch of FIG. 2. The user interface 300 displayed in the form of an analog watch includes an hour hand 310 and a minute hand 320 to indicate an original broadcasting time of a program which is currently being played in the screen. If a user is watching a broadcast program which is being broadcast as the user watches it (i.e. the user is not watching a recording), the hour hand 310 and the minute hand 320 of the watch 300 indicate the current time which is also the time at which the program being watched was broadcast. However, if the user is watching a program that was broadcasted in the past and recorded, the hour hand 310 and the minute hand 320 of the watch 300 do not show the current time, but rather the time at which the watched program was originally broadcast. In the watch 300, a time shift to the past broadcasting time is indicated by a fan shape 350 in a time band. A first end 330 of a circular arc of the fan shape 350 indicates the time at which the PVR began recording the recorded program. A second end 340 of the circular arc 350 indicates the time at which the recorded program stopped being recorded or the current time if the program is still being recorded. Referring to FIG. 3, the recording of the program that is currently being played began at 11:28 and has been recorded for 39 minutes up to the current time of 12:07. The portion of the program currently being watched, as indicated by the hour and minute hands, was originally broadcast at the current time of 12:07. That is the user is watching the portion of the recorded program that is currently being broadcast. Since the entire circle of the clock indicates 60 minutes, each 6° indicates a minute of recording of a program.

FIG. 4 is a flowchart of a method of a user interface for a time shift function according to an embodiment of the present invention. First, when a time shift function is activated by a user via a user input device, a user interface is displayed on a screen in the form of an analog watch (operation S402).

Next, a broadcasting time of a currently playing program (i.e. the time at which the currently watched portion of a recorded program was originally broadcast) is displayed on the user interface (operation S404). The broadcasting time of the currently playing program may be displayed using the hour hand and the minute hand of the analog watch, as described above. Also, whether the currently playing program was previously recorded or is currently being broadcast may be visually indicated with different colors, for example.

Further, a status of the recording of the currently-played program is displayed on the user interface (operation S406). The status of program recording includes information on a recording duration which indicates how long the currently-played program has been recorded for, and information on recording times, which indicates the times at which the currently-played program is recorded. The recording duration is indicated by a particular figure, and the size of the figure may change in proportion to the duration of the program. The recording times of the program is indicated by the topology or location of the figure. For example, according to an exemplary embodiment of the present invention, since analog watches normally have a circular shape, the recorded program may be illustrated by a circular arc, or a fan shape whose circular arc is connected to the center of a circle as shown in FIG. 3. In this case, the area of the fan shape may indicate the duration of the recording of the currently-played program, and the position of the fan shape may indicate a the staring time, and the ending time of the recording. A circular arc or fan shape which completes a full circle may indicate that a maximum recording time has been reached based on storage capacity of the PVR. However, the shape and figure of the analog watch are not limited to the particular form described above, and it will be understood by those skilled in the art that the shape and figure thereof may vary.

When a time shift instruction is received (operation S408), the locations of the hour hand and the minute hand change so as to indicate a certain time in response to the time shift instruction (operation S404).

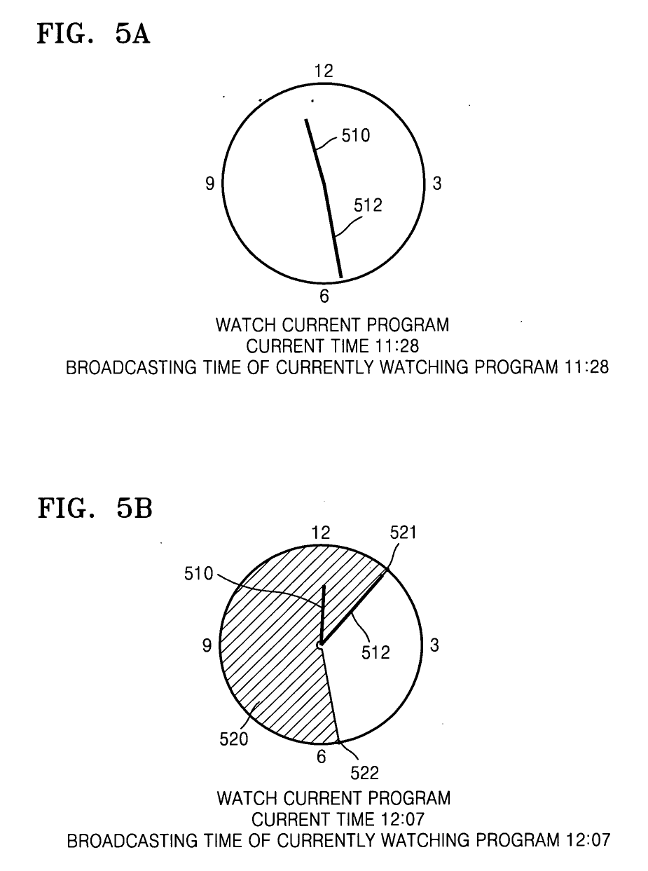

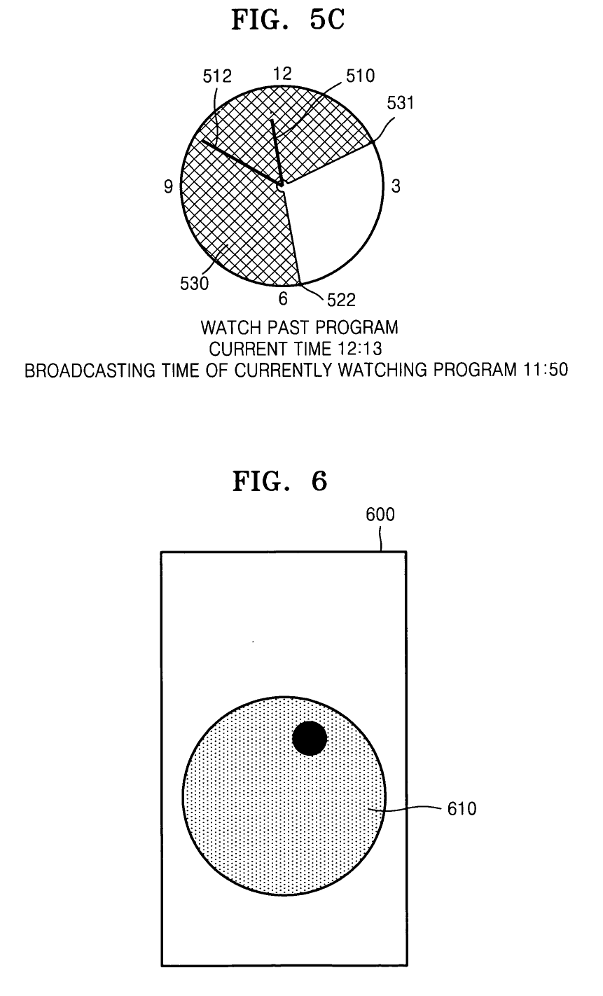

FIGS. 5A to C show the operations of a user interface for a time shift according to an embodiment of the present invention.

Referring to FIG. 5A, a user turns on the PVR at 11:28 and starts to watch a broadcast program of a specific channel, or the user activates a time shift function for the first time. The user is watching a program as it is currently being broadcast. A figure for indicating a status of program recording is not displayed because there are no recorded broadcast programs. An hour hand 510 and a minute hand 512 indicate the time at which the currently played program was originally broadcast, which, in this case, is the current time, 11:28, because the user is watching a current program rather than a previously recorded program.

FIG. 5B shows a user interface displayed on a screen at 12:07. Referring to FIG. 5B, the time at which a currently playing portion of a recorded program was originally broadcast is indicated by the hour hand 510 and minute hand 521, and a fan shape 520 indicates the time during which the currently-played program was recorded. A first end 522 of the fan shape indicates the time at which recording of the currently-played program began, and a second end 521 of the fan shape indicates the time at which recording of the currently-played program ended. In this case, an extended line of the minute hand 512 (which indicates the time at which the currently-watched portion of the program was originally recorded) overlaps the second end 521 of the fan (which indicates the end recording time of the currently-played program) indicating that the user is watching the program as it is currently being broadcast. Also, it can be seen that the recording of the currently-played program has been going for 39 minutes, starting at 11:28, as indicated by the first end 522 of the fan shape, and ending at the current time of 12:07, as indicated by the second end 512 of the fan shape.

FIG. 5C shows a case in which the current time is 12:13 and a user has input a time shift instruction to play a portion of a program that was broadcast at 11:50. To indicate the original broadcasting time of the currently playing portion of the program, the hour hand 510 and the minute hand 512 are shifted. The second end 531 of the circular arc shows that the currently-played program has been recorded up to the present time of 12:13. Also, to further distinguish from the case as shown in FIG. 5B in which the currently-played portion of the program is also being currently broadcast, the fan shape 530 indicating the duration of the recording may be displayed in a different color.

FIG. 6 shows an example of a user input device according to an embodiment of the present invention. To facilitate the operation of a time shift function using a user interface of the present invention, a remote controller 600 including a jog wheel 610 may be used. When a user rotates the jog wheel 610 in a clockwise direction, the currently-played program is advanced, and when a user rotates the jog wheel 610 in a counter-clockwise direction, the currently-played program is reversed to reach a portion of the program which was broadcast in the past. The extent of time shift is predetermined according to a degree and direction of rotation of the jog wheel 610.

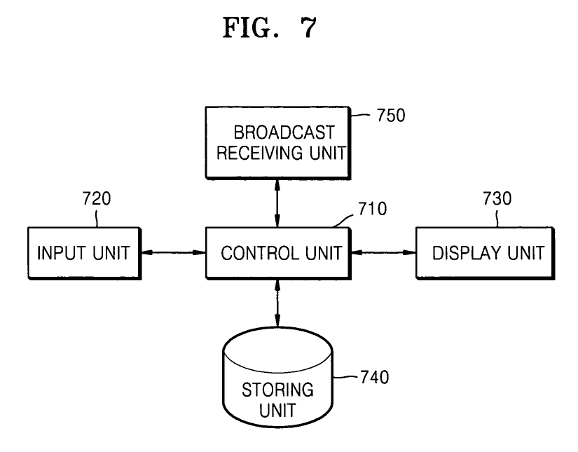

FIG. 7 is a block diagram of a PVR using a user interface for a time shift according to an embodiment of the present invention. Referring to FIG. 7, the PVR includes a broadcast receiving unit 750 which receives broadcast data, a storing unit 740 which stores the received broadcast data, a display unit 730 which is used to display a user interface for a time shift and to play the broadcast data, and a control unit 710 which controls playing and recording of the received broadcast data. The control unit displays the user interface for the time shift in the form of an analog watch on the display unit 730, and displays a broadcasting time of a program that is currently played on the display unit 730 and a status of broadcasting recording on the user interface. The PVR also includes an input unit 720 to which a user instruction is input. When the control unit 710 displays the user interface, the user interface is displayed according to the aforementioned user interface method. When a time shift instruction is received through the input unit 720, a time corresponding to the received time shift instruction is indicated by chaining the hour hand and the minute hand of the interface. The input unit 720 may include the aforementioned jog wheel.

Accordingly, the present invention provides a user interface displayed in the form of an analog watch that is familiar to ordinary users, so that a status of the operation of a time shift can be simply and intuitively displayed. Therefore, a user who is not skilled in operating a time shift function can easily use the function.

In addition, an input device including a jog wheel having a similar form of the analog watch is used to provide a user friendly user interface.

Meanwhile, the embodiments of the present invention can be written as computer programs and can be implemented in general-use digital computers that execute the programs using a computer readable recording medium.

Although the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of displaying a user interface for displaying a status of reproducing and/or recording of broadcast, the method comprising:
displaying a user interface on a screen, wherein the user interface is in the form of an analog watch;
displaying, on the user interface, a broadcasting time of a currently playing program; and
displaying a status of broadcast recording on the user interface.

2. The method of claim 1, wherein the displaying the broadcasting time of the currently playing program comprises displaying at least one of an hour hand and a minute hand which indicate the broadcasting time of the program.

3. The method of claim 1, wherein the displaying the status of broadcast recording comprises displaying a figure on the user interface, wherein a size of the figure changes in proportion to the duration of the program.

4. The method of claim 3, wherein the displaying the status of broadcast recording further comprises changing a position of the figure according to the broadcasting time of the program.

5. The method of claim 1, further comprising displaying, on the user interface, information on whether a currently displayed portion of the program is a recorded portion or a portion which is currently being broadcast

6. The method of claim 5, wherein the displaying information on whether the currently displayed portion of the program is a recorded potion or a portion which is currently being broadcast comprises displaying the information on whether the currently playing program is a recorded broadcast program or a current broadcast program by using different colors.

7. The method of claim 2, wherein the displaying the status of broadcast recording comprises displaying the duration of the program using a circular arc.

8. The method of claim 7, wherein a first end of the circular arc indicates a recording starting time, and a second end of the circular arc indicates a current time.

9. The method of claim 8, wherein the second end of the circular arc meets an extended line of the minute hand indicating the current time, and the first end of the circular arc is spaced apart from the second end of the circular arc in a counter clockwise direction by a certain degree, wherein each six degrees of a central angle indicates a recording time of one minute.

10. The method of claim 9, wherein the displaying the duration of the program comprises indicating the duration of recording in the form of a fan shape that is formed by the area between the center of the user interface and the circular arc.

11. The method of claim 2, further comprising:
receiving a time shift instruction; and
changing the locations of at least one of the hour hand and the minute hand to indicate a time in response to the time shift instruction.

12. An apparatus of reproducing and/or recording broadcast data, the apparatus comprising:
a broadcast receiving unit which receives broadcasting data;
a storing unit which stores the received broadcasting data;
a display unit which displays a user interface for a time shift and which plays the broadcasting data; and
a control unit which controls playing and recording of the received broadcast data, displays the user interface for the time shift in the form of an analog watch on the display unit, and controls the display unit to display a broadcasting time of a currently playing program and a status of broadcasting recording.

13. The apparatus of claim 12, wherein the control unit controls the display unit to display an hour hand and a minute hand which indicate the broadcasting time of the currently playing program.

14. The apparatus of claim 13, wherein the control unit controls the display unit to display a figure on the user interface which indicates the status of broadcasting recording, wherein a size of the figure changes in proportion to the duration of the program and wherein a position of the figure changes according to changes in the broadcasting time of the program.

15. The apparatus of claim 14, wherein the figure has a fan shape, and a first end of a circular arc of the fan shape indicates a recording starting time, and a second end of the circular arc indicates a current time.

16. The apparatus of claim 13, further comprising an input unit which receives a user instruction,
wherein, when the control unit receives a time shift instruction via the input unit, the control unit controls the display unit to change the locations of at least one of the hour hand and the minute hand in response to the time shift instruction.

17. The apparatus of claim 16, wherein the input unit comprises a jog wheel, and the time shift instruction is transmitted to the control unit according to a rotation direction of the jog wheel.
